(19) United States
(12) Patent Application Publication
(10) Pub. No.: US 2026/0127897 A1
(43) Pub. Date: May 7, 2026

(54) Multistage Audio-Visual Automotive Cab Monitoring

(71) Applicant: Blueskeye AI Ltd, Nottingham (GB)

(72) Inventors: Michel François Valstar, Nottingham (GB); Anthony Brown, Nottingham (GB); Timur Almaev, Nottingham (GB); Thomas James Smith, Sheffield (GB); Tze Ee Yong, Nottingham (GB); Mani Kumar Tellamekala, Nottingham (GB)

(21) Appl. No.: 19/437,796

(22) Filed: Dec. 31, 2025

Related U.S. Application Data
(62) Division of application No. 18/364,709, filed on Aug. 3, 2023.
(60) Provisional application No. 63/370,840, filed on Aug. 9, 2022.

(51) Int. Cl. G06V 20/59; B60W 60/00; G06F 3/16; G06T 7/246; G06V 10/80; G06V 10/82; G06V 10/98; G06V 20/40; G06V 20/52; G06V 40/16; G06V 40/20; G08B 21/04

(52) U.S. Cl. CPC G06V 20/597; G06F 3/167; G06T 7/246; G06V 10/80; G06V 10/82; G06V 10/993; G06V 20/46; G06V 20/52; G06V 40/161; G06V 40/20; G08B 21/0476; B60W 60/0051; B60W 2540/22; G06T 2207/30201; G06T 2207/30232; G06T 2207/30268; G06V 2201/10

(57) ABSTRACT

Described is a task for an automobile interior having at least one subject that creates a video input, an audio input, and a context descriptor input. The video input relates to the at least one subject and is processed by a face detection module and a facial point registration module to produce a first output. The first output is further processed by at least one of: a facial point tracking module, a head orientation tracking module, a body tracking module, a social gaze tracking module, and an action unit intensity tracking module. The audio input relating to the at least one subject is processed by a valence and arousal affect states tracking module to produce a second output and to produce a valence and arousal scores output. A temporal behavior primitives buffer produce a temporal behavior output. Based on the foregoing, a mental state prediction module predicts the mental state of at least one subject in the automobile interior.

### PRIOR APPLICATIONS

This application claims the benefit of the following application, which is incorporated by reference in its entirety:
U.S. Provisional Patent Application No. 63/370,840, filed on Aug. 9, 2022.

### FIELD OF THE DISCLOSURE

The present disclosure relates generally to improved techniques in monitoring audio-visual activity in automotive cabs.

### BACKGROUND

Monitoring drivers is necessary for safety and regulatory reasons. In addition, passenger behavior monitoring is becoming more important to improve user experience and provide new features such as health and well-being-related functions.

Automotive cabins are a unique multi-occupancy environment that has a number of challenges when monitoring human behavior. These challenges include:
Significant visual noise caused by rapidly changing and varied lighting conditions:
Significant audio noise from the road, radios and open windows;
Suboptimal camera angles lead to frequent occlusion and extreme head pose; and
Multi-occupancy can lead to confusion about the source of audio signals or the potential focus of attention.

Current in-cab monitoring solutions, however, rely solely on visual monitoring via cameras and are focused on driver safety monitoring. As such these systems are limited in their accuracy and capability. A more sophisticated system is needed for in-cab monitoring and reporting.

### SUMMARY

This disclosure proposes a confidence-aware stochastic process regression-based audio-visual fusion approach to in-cab monitoring. It assesses the occupant's mental state in two stages. First, it determines the expressed face, voice, and body behaviors as can be readily observed. Second, it then determines the most plausible cause for this expressive behavior, or provides a short list of potential causes with a probability for each that it was the root cause of the expressed behavior. The multistage audio-visual approach disclosed herein significantly improves accuracy and enables new capabilities not possible with a visual-only approach in an in-cab environment.

### BRIEF DESCRIPTION OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIG. 1 shows an architecture of inputs and outputs for an in-cab temporal behavior pipeline.

FIG. 2 shows an overview of a structure of a Visual Voice Activity Detection model.

FIG. 3 shows the accuracy of a Visual Voice Activity Detection model.

FIG. 4 shows the comparison of a 1-second buffer and a 2-second buffer of a Visual Voice Activity Detection model.

FIG. 5 shows the comparison of F1, precision, recall, and accuracy for Visual Voice Activity Detection model and an Audio Voice Activity Detection model.

FIG. 6 shows a block diagram of a confidence-aware audio-visual fusion model.

FIGS. 7A, 7B, and 7C show evidence of improved accuracy and reduced false positive rate for a noise-aware audio-visual fusion technique.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### I. DEFINITIONS AND EVALUATION METRICS

In this disclosure, the following definitions will be used:
AU-Action Unit, the fundamental actions of individual muscles or groups of muscles, identified by FACS (Facial Action Coding System), which was updated in 2002;
VVAD-Visual Voice Activity Detection (processed exclusive of any audio); and
AVAD-Audio Voice Activity Detection (processed exclusive of any video).
The evaluation metrics used to verify the models' performance are the following
Precision is defined as the percentage of correctly identified positive class data points from all data points identified as the positive class by the model.
Recall is defined as the percentage of correctly identified positive class data points from all data points that are labelled as the positive class.
F1 is a metric that measures the model's accuracy performance by calculating the harmonic mean of the precision and recall of the model. F1 is calculated as follows:

$$F 1 = 2 \frac{precision * recall}{precision + recall}$$

F1 is a commonly used because it reliably measures the accuracy of the model regardless of the imbalanced nature of datasets. Higher is better.

False Positive Rate (FPR) is defined as the rate in which events are wrongly classified as positive events.

$$FPR = \frac{false positives}{false positives + true negatives}$$

The FPR metric is used to identify how reliably the model correctly identifies a positive event. This is an essential metric for evaluating systems to reduce false alarms from happening. Lower is better.

### II. IN-CAB TEMPORAL BEHAVIOR PIPELINE

### A. Architecture Schematic for In-Cab Temporal Behavior Pipeline

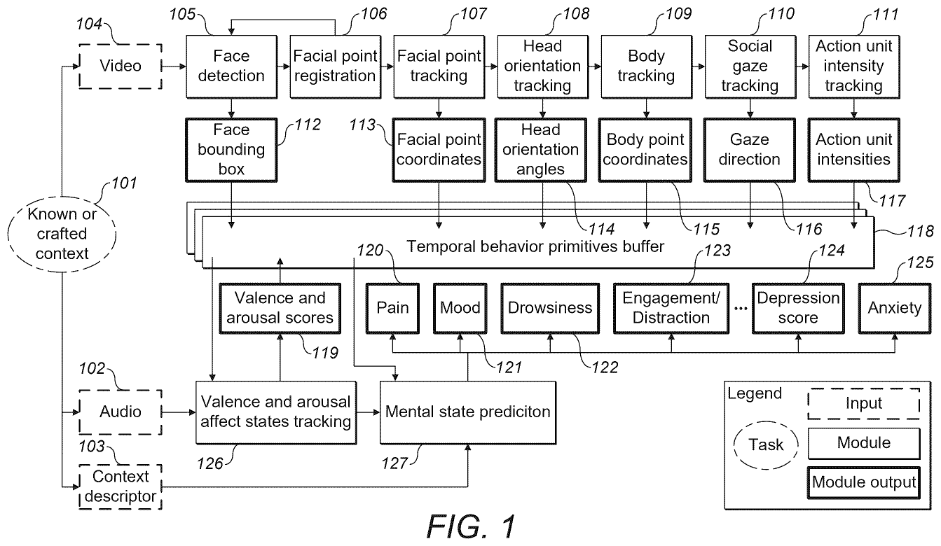

FIG. 1 shows a high-level overview of the architecture of inputs and outputs for an in-cab temporal behavior pipeline. The architecture shows a task for an automobile interior having at least one subject that creates a video input, an audio input and a context descriptor input.

Specifically, shown is schematic 100 with a task of known or crafted context 101 for at least one subject in an automobile interior that creates video 104, audio 102, and context descriptor 103 inputs based on the at least one subject.

The video 104 input results in face detection 105 and facial point registration 106 modules, which leads to a facial point tracking 107 module, which leads to a head orientation tracking 108 module, which leads to a body tracking 109 module, which leads to a social gaze tracking 110 module, which leads to action unit intensity tracking 111 module.

The face detection 105 module produces a face bounding box 112 output. The facial point tracking 107 module produces a set of facial point coordinates 113 output. The head orientation tracking 108 module produces head orientation angles 114 output. The body tracking 109 module produces body point coordinates 115 output. The social gaze tracking 110 module produces gaze direction 116 output. The action unit intensity tracking 111 module produces action unit intensities 117 output. The results of each output of the face bounding box 112, facial point coordinates 113, head orientation angles 114, body point coordinates 115, gaze direction 116, and action unit intensifies 117 are loaded into the temporal behavior primitives buffer 118.

The audio 102 input results in valence and arousal affect states tracking 126 module, which leads to a mental state prediction 127 module. The valence and arousal affect states tracking 126 module is further informed by the temporal behavior primitives buffer 118. The mental state prediction 127 module is further informed by the context descriptor 103 input and the temporal behavior primitives buffer 118.

The valence and arousal affect states tracking 126 module produces a valence and arousal affect states tracking 119 output. The results of the arousal affect states tracking 119 output are loaded into the temporal behavior primitives buffer 118.

The mental state prediction 127 module produces, among others, a pain 120 output, a mood 121 output, a drowsiness 122 output, an engagement/distraction 123 output, a depression 124 output, and an anxiety 125 output.

### B. Benefits of the Architecture Schematic for In-Cab Temporal Behavior Pipeline

The foregoing architecture schematic has the following broad benefits:
Allows the system to visually verify which occupant is creating the audio signal significantly reducing false positives;
Allows the system to work effectively if either the audio or visual channel is degraded by noise;
Allow the detection of significantly more behaviors at a substantially higher accuracy than visual or audio monitoring alone;
Allows maintaining multiple potential causes for the behaviors, which allows a control system to make changes to the environment or query the occupant so as to hone in on the cause of the behavior beyond doubt over time;
Allows the car system to know when there's insufficient evidence to take any action;
Allows the use of behavior and mental state measurement to decide when it is appropriate for the ADAS (advanced driver assistance system) or self-driving system to take or relinquish control of the vehicle to the driver; and
Allows the detection of extreme health and incapacitation events and enables first responders to be called by the cars emergency communication/SOS system and provide the correct data related to the occupant's condition.

This is expected to significantly improve in-cab monitoring in the following areas.

### 1. Driver Behavior

Monitoring driver attention on the driving task;
Detecting emotional distractions for example, upset and angry driving;
Detecting squinting due to bright sunlight and glare; and
Detecting sudden incapacitation events-such as strokes and heart attacks.

### 2. Passenger Behavior

Searching for lost items;
Expressed fear—to modify driving behavior; and
Reading or using a screen—can be useful when considering motion sickness.

### 3. Well-being Measurements of Driver and Passenger

Behaviors related to the onset of motion sickness—to enable the activation of motion sickness countermeasures;
Coughing;
Sneezing;
Expressed mood including low persistent mood; and
Allergic reactions or similar responses to the cabin environment.

### 4. Recognition and Monitoring of Long-Term or Degenerative Behavior Medical Conditions

Major Depressive disorder;
Alzheimer's;
Dementia;
Parkinson's;
ADHD (attention deficit hyperactivity disorder); and
Autism Spectrum Disorder (ASD).

### 5. Recognition and Detection of Extreme Health Events

Heart attacks;
Stroke;
Loss of consciousness; and
Dangerous diabetic coma

This opens up a whole new set of in-cab interactions and features that would be of interest to auto manufacturers and suppliers in the automotive industry.

Set forth below is a more detailed description of how some of the more automotive-focused behaviors are detected. Detection of this behavior may use all, some, or none of the features of the foregoing architecture schematic.

### III. AUDIO-VISUAL VERIFICATION FOR ATTRIBUTING SOUNDS TO AN INDIVIDUAL PASSENGER

Vehicle noises are difficult to attribute to an individual due to there often being more than one passenger in the vehicle. Directional microphones help but do not fully solve the problem.

A temporal model may be trained to learn the temporal relationships between audio features and facial appearance over a specified time window via facial muscular actions captured on video. Such actions are specifically but not limited to:
AU 9 (nose wrinkler);
AU 10 (upper lip raiser);
AU 11 (nasolabial deepener);
AU 22 (lip funneler);
AU 18 (lip pucker); and
AU 25 (lips part).

This essentially verifies the consistency between what is seen in the video and the audio collected. This technique significantly reduces false positives when monitoring users for:
Speech;
Sneezing;
Coughing;
Clearing the throat; and
Sniffling.

This is useful in detecting behaviors relating to motion sickness, hay fever coughs, and colds.

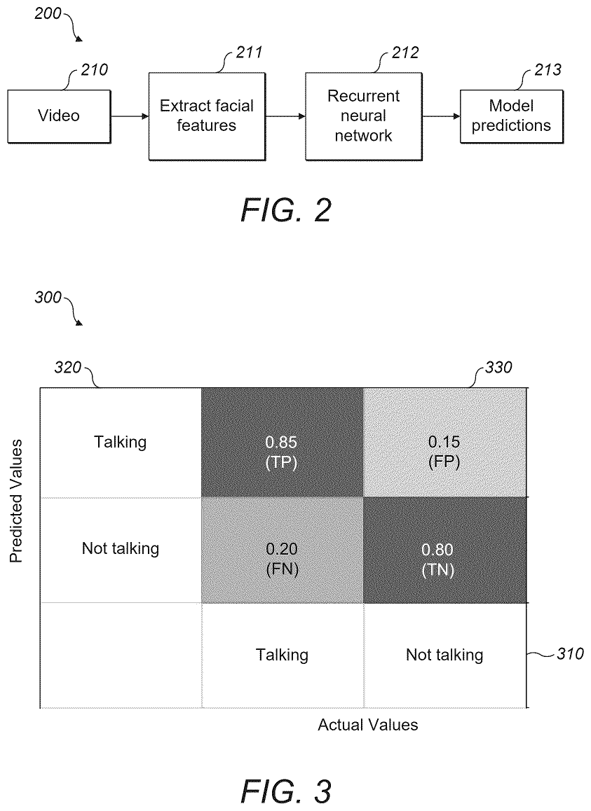

FIG. 2 shows an overview of the structure of a VVAD model for attributing sounds to an individual passenger. Shown is a schematic 200 where video 210 is reviewed to extract facial features 211, which is fed into a recurrent neural network 212 (RNN) to produce model predictions 213.

### Example 1

In this Example 1, a VVAD model was used with a temporal window of between 0.5 and 3 seconds at framerate of 5 to 30 frames per second (FPS).

The VVAD models uses the following inputs set forth in Table 1.

TABLE 1

| Feature | Type | Notes |
|---|---|---|
| nose tip and | Geometric | Relative/normalized distance. |
| central lower lip | | This feature showed high |
| midpoint | | correlation with the talking |
| | | class, this is similar to the lip |
| | | parting but removes any |
| | | variation caused by the upper |
| | | lip. |
| inner mouth | Geometric | Relative/normalized distance. |
| corners | | This helps with phonemes that |
| | | contract the lips width ways. |
| upper and lower | Geometric | This is the most important |
| central lip | | feature as during speech the |
| midpoints | | proportion of phonemes that part |
| | | the lips is very high. |
| AU 25 predicted | Facial muscle | Temporal dynamics of AU 25 |
| value | action | showed high correlation with the |
| | | talking class. |
| AU 22 predicted | Facial muscle | Temporal dynamics of AU 22 |
| value | action | showed high correlation with the |
| | | talking class. |
| AU 18 predicted | Facial muscle | Temporal dynamics of AU 18 |
| value | action | showed high correlation with the |
| | | talking class. |

For outputs, the VVAD model used the output of one-hot encoding of either “talking” [0,1] or “not talking” [1,0] for the current frame given the previous 5 to 60 frames, depending on frame rate and buffer size.

For training data and annotations, the dataset for training VVAD and validation of VVAD consisted of 150 in-cabin videos. These were then labelled manually for the “Driver: Not Speaking” and the “Driver: Speaking” classes.

The VVAD model was trained on samples where the temporal sections have a uniform label, that is either “all talking” or “all not talking.” This was calculated using a sliding window over the dataframe. When all the labels were the same, this is flagged as a valid sample. There were no overlapping samples in the datasets for training and validation.

### Example 2

In this Example 2, the model was trained on 53,118 samples, consisting of 43,635 “talking” samples, and 9,483 “not talking” samples. During training, the samples were weighted to equalize their impact.

The validation set consists of 33,655 samples, consisting of 29,690 “talking” samples, and 3,965 “not talking” samples.

This produced the following results:
Total positives: 21,327;
Total negatives: 5,810;
False positives: 1,023; and
False negatives: 5,495.

These results generate a precision of 0.954=21,327/(21,327+1,023), and a recall of 0.795=21,327/(21,327+5,495).

The precision and recall scores result in a F1 score of 0.867=2*((0.954*0.795)/(0.954+0.795)).

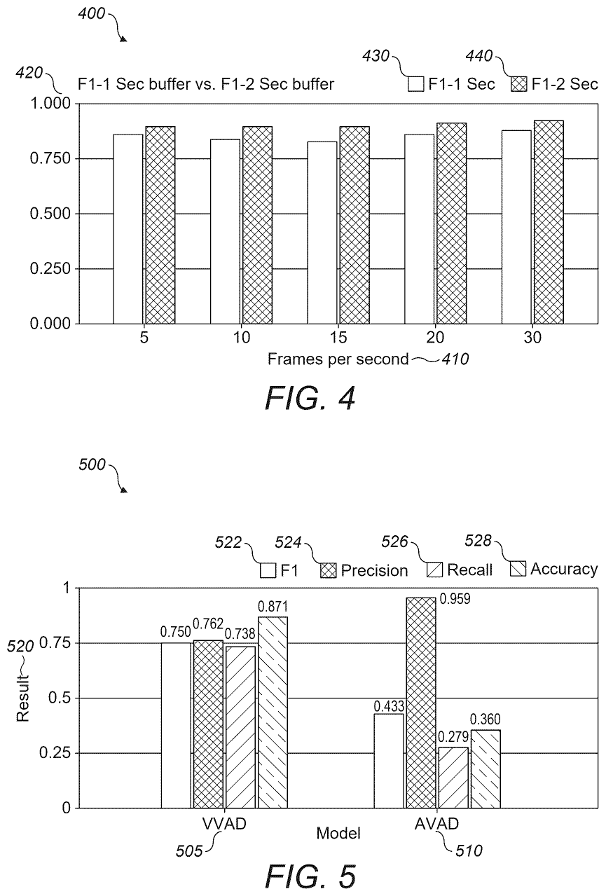

FIG. 3 shows the model accuracy of Example 2. Shown is a schematic 300 showing talking/not talking “Actual Values” 310 on the x-axis, and talking/not talking “Predicted Values” 320 on the y-axis. The results 330 show the confusion matrix containing the values of True Positive Rate (TP), False Positive Rate (FP), False Negative Rate (FN), and True Negative Rate (TN).

To determine the optimal frame rate and buffer length, Table 2 shows that the VVAD model of Example 2 is able to achieve good precision and recall at frame rates between 5 and 30 frames per second (FPS). Performance improves as the frame rate increases.

TABLE 2

| | Total | False | False | Total | | | | | |
|---|---|---|---|---|---|---|---|---|---|
| ID | Negatives | Negatives | Positives | Positives | | | | | |
| (FPS/ | 0/0 | 0/1 | 1/0 | 1/1 | | | | | |
| Buffer) | (P/A)* | (P/A)* | (P/A)* | (P/A)* | Total | Accuracy | Precision | Recall | F1 |
| 5 FPS | 4,987 | 5,007 | 591 | 17,219 | 27,804 | 79.866% | 0.967 | 0.775 | 0.860 |
| 1 Sec | | | | | | | | | |
| 10 FPS | 5,724 | 5,605 | 480 | 15,995 | 27,804 | 78.115% | 0.971 | 0.741 | 0.840 |
| 1 Sec | | | | | | | | | |
| 15 FPS | 6,210 | 5,831 | 441 | 15,322 | 27,804 | 77.442% | 0.972 | 0.724 | 0.830 |
| 1 Sec | | | | | | | | | |
| 20 FPS | 6,195 | 4,980 | 456 | 16,173 | 27,804 | 80.449% | 0.973 | 0.765 | 0.856 |
| 1 Sec | | | | | | | | | |
| 30 FPS | 7,074 | 3,931 | 493 | 16,306 | 27,804 | 84.089% | 0.971 | 0.806 | 0.881 |
| 1 Sec | | | | | | | | | |
| 5 FPS | 5,615 | 3,447 | 366 | 16,607 | 26,035 | 85.354% | 0.978 | 0.828 | 0.897 |
| 2 Sec | | | | | | | | | |
| 10 FPS | 6,513 | 3,274 | 316 | 15,932 | 26,035 | 86.211% | 0.981 | 0.830 | 0.899 |
| 2 Sec | | | | | | | | | |
| 15 FPS | 7,171 | 3,140 | 314 | 15,410 | 26,035 | 86.733% | 0.980 | 0.831 | 0.899 |
| 2 Sec | | | | | | | | | |
| 20 FPS | 7,153 | 2,649 | 332 | 15,901 | 26,035 | 88.550% | 0.980 | 0.857 | 0.914 |
| 2 Sec | | | | | | | | | |
| 30 FPS | 8,514 | 2,149 | 273 | 15,099 | 26,035 | 90.697% | 0.982 | 0.875 | 0.926 |
| 2 Sec | | | | | | | | | |

*(P/A): Predicted/Actual

The number of samples for the 2 second buffer is less than the number of samples for the 1 second buffer because some samples were unusable when the buffer length was increased from 1 second to 2 seconds.

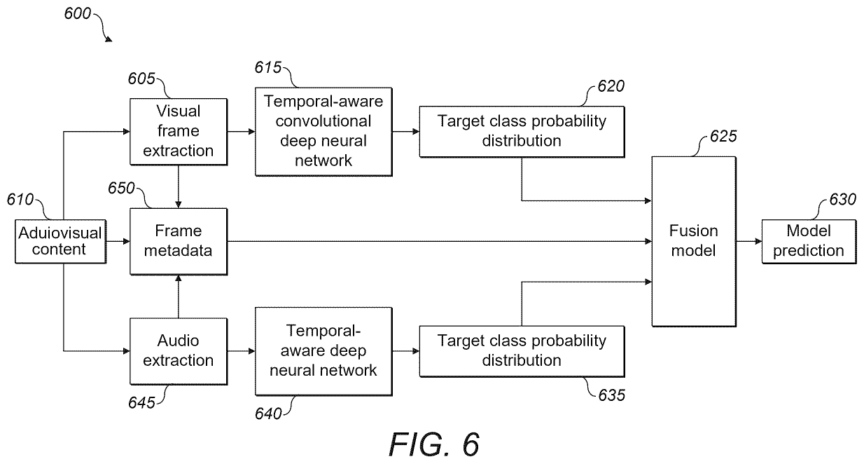

FIG. 4 shows the F1 comparison based on the data in Table 2. The bar graph 400 shows an x-axis 410 of FPS and y-axis of F1. The white bars 430 are for data with a 1-second buffer and the shaded bars 440 are for data with a 2-second buffer.

For each FPS setting, the graph in FIG. 4 shows that F1 is higher (and thus better) for a 2-second buffer than a 1-second buffer. The graph in FIG. 4 also shows that F1 is best for 30 FPS for each of the 1-second buffer and the 2-second buffer.

### Example 3

In this Example 3, a selection of 480 videos were identified where there were multiple occupants talking, or where someone was talking with a radio on in the background, or where the occupant is talking on the phone handsfree. The AVAD and VVAD systems were each run using these video selections. The results are shown in Table 3.

TABLE 3

| | Total | False | False | Total | | | | | |
|---|---|---|---|---|---|---|---|---|---|
| | Negatives | Negatives | Positives | Positives | | | | | |
| Model | 0/0 (P/A) | 0/1 (P/A) | 1/0 (P/A) | 1/1 (P/A) | Total | Accuracy | Precision | Recall | F1 |
| VVAD | 325 | 33 | 29 | 93 | 480 | 87.083% | 0.762 | 0.738 | 0.750 |
| AVAD | 56 | 302 | 5 | 117 | 480 | 36.042% | 0.959 | 0.279 | 0.433 |

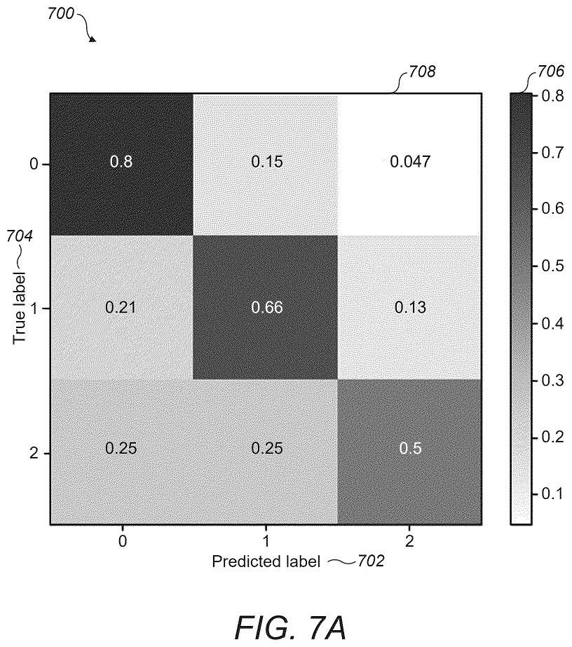

FIG. 5 shows the data in Table 3 in graph form. Shown is a bar graph 500 comparing results 520 on the y-axis for the VVAD model 505 and the AVAD model 510 on the x-axis. The bars show the results for F1 522, precision 524, recall 526, and accuracy 528.

The data in Example 3 show that the VVAD model operates significantly better than the AVAD model. Specifically, the F1 score of 0.750 of the VVAD model is significantly higher than the F1 score of 0.433 of the AVAD model.

Example 2 thus demonstrates that the proposed/claimed VVAD model achieves good generalization accuracy on the validation set. With high frame rates (30 FPS) and increasing temporal buffer lengths (2 sec), the model's accuracy can be improved noticeably. Example 3 shows that the VVAD model has fewer false positives compared to the AVAD model. This result demonstrates the robustness of the proposed VVAD model with respect to the AVAD model in operating conditions with background voice activity.

### IV. NOISE-AWARE AUDIO-VISUAL FUSION TECHNIQUE

In-cab monitoring is susceptible to visual noise caused by rapidly changing and varied lighting conditions and suboptimal camera angles. In-cab monitoring is also susceptible to auditory noise caused by other passengers, radios, and road noise.

Described herein is a novel confidence-aware audio-visual fusion approach that allows confidence score output by the model prediction to be considered during the fusion and classification process. This reduces false positives and increases accuracy in the following cases:
Sneeze detection (visual features are very useful in the pre-sneeze phase but the face is often occluded or blurred during the actual sneeze);
Expressed emotion prediction; and
Monitoring of long-term or degenerative behavior medical conditions (it is essential here that only high-quality data is used as input to the models).

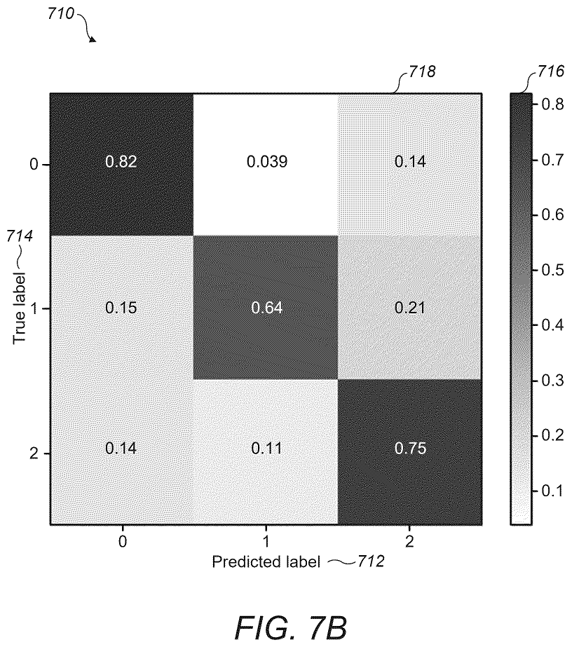

Turning to FIG. 6, shown is a block diagram 600 of a confidence-aware audio-visual fusion model. Audiovisual content 610 is subject to visual frame extraction 605 and audio extraction 645. Frame metadata 650 is obtained from both the visual frame extraction 605 and the audio extraction 645 and is then sent to the fusion model 625. The visual frame extraction 605 is loaded into a temporal-aware convolutional deep-neural network 615, is then analyzed via a target class probability distribution 620, and is then sent to the fusion model 625. The audio extraction 645 is loaded into a temporal-aware deep-neural network 640, is then analyzed via a target class probability distribution 635, and is then sent to the fusion model 625. The results from the fusion model 625 are then produced as a model prediction 630.

The visual model uses AUs, head poses, transformed facial landmarks, and eye gaze features as inputs. This is further detailed in Table 4.

TABLE 4

| Input | | |
|---|---|---|
| Feature | Notes | Importance |
| Head pose | Head rotation in | The temporal dynamics of the head |
| roll | roll angle | pose roll angle show high correlation |
| | | with the labels. |
| Head pose | Head rotation in | The temporal motion of coughs and |
| pitch | pitch angle | sneezes tend to have high correlation |
| | | with this feature. |
| Head pose | Head rotation in | Tends to turn head sideways during |
| yaw | yaw angle | coughs or sneezes. |
| Transformed | Relative/normalized | Captures the overall geometric |
| facial | angles and distances | patterns of facial muscles actions that |
| landmarks | between selected | occur during coughs and sneeze |
| | facial landmarks | events. |
| AU 25 | Lips parting action | Lips part in coughs and sneezes |
| | unit | action. |
| AU 05 | Upper eyelid raiser | For sneeze, this particular action unit |
| | action unit | is important. |
| AU 06 | Cheek raiser action | Eyes tend to squint during coughs |
| | unit | and sneezes, which activates this |
| | | action unit. |
| AU 07 | Eyelid tightener | Eyes tend to squint during coughs |
| | action unit | and sneezes, which activates this |
| | | action unit. |
| AU 15 | Lip corner depressor | For coughs and sneezes, this |
| | action unit | particular action unit is important. |
| AU 01 | Inner eyebrow raiser | For sneeze, this particular action unit |
| | action unit | is important. |
| AU 14 | Dimpler action unit | The temporal dynamics of AU 14 |
| | | show high correlation with the labels. |
| Gaze | Eye gaze coordinate | Gaze changes in accordance with |
| vector x | along the X axis | head movement. |
| Gaze | Eye gaze coordinate | Gaze changes in accordance with |
| vector y | along the Y axis | head movement. |
| Gaze | Eye gaze coordinate | Gaze changes in accordance with |
| vector z | along the Z axis | head movement. |
| Gaze yaw | Eye gaze in | Gaze changes in accordance with |
| | yaw angle | head movement. |

The audio model may use the log-mel spectrogram of the captured audio clip. The log-mel spectrogram is computed from 2 seconds long of captured raw audio sampled at 44100 Hz, sampling from the frequency range of 80 Hz to 7600 Hz, with a mel-bin size of 80. This produces the log-mel spectrogram of size (341×80) which is then min-max normalized with values (−13.815511, 5.868045) before passing into the audio model as input. Any form of transformed audio features or time-frequency domain features (such as spectrograms, mel frequency cepstral coefficients, etc.) may be used instead.

For the fusion approach combining the Audio-only and Visual-only models, the inputs may be: (a) the output probability distribution of Audio-only model: (b) the output probability distribution of Visual-only model; and (c) Frame metadata (information on the quality of the input buffer data).

Frame metadata for video may include: (a) percentage of tracked frames; and (b) number of blurry/dark/light frames; and (c) other image quality metrics. Frame metadata for audio may include temporal (or time) domain features, such as: (a) short-time energy (STE): (b) root mean square energy (RMSE): (c) zero-crossing rate (ZCR); and (d) other audio quality metrics, each of which gives information into the quality of the audio window.

The output of the models may be the normalized discrete probability distribution (softmax score) of 3 classification categories: (a) negative class (any non-cough and non-sneeze events) (class 0): (b) cough class (class 1); and (c) sneeze class (class 2).

### Example 4

In this Example 4, the discrete probability distribution of each of the three classes (negative, cough, sneeze) from each modality branch (audio, visual) was used in the fusion process. The discrete probability distribution from each branch was combined via concatenation, then passed into the fusion model as input. The data used for training and evaluating this Example 4 consists of a combination of videos gathered from consenting participants gathered through data donation campaigns. Table 5 summarizes the training set.

TABLE 5

| Training Set | | | Onset | Active | Total |
|---|---|---|---|---|---|
| Class | Subjects | Videos | frames | frames | frames |
| Negative | 142 | 181 | — | 125,014 | 125,014 |
| (Class 0) | | | | | |
| Cough | 46 | 128 | 0 | 4,541 | 4,541 |
| (Class 1) | | | | | |
| Sneeze | 173 | 304 | 5,481 | 940 | 6,421 |
| (Class 2) | | | | | |

Table 6 summarizes the validation set.

TABLE 6

| Validation | | | Onset | Active | Total |
|---|---|---|---|---|---|
| Set Class | Subjects | Videos | frames | frames | frames |
| Negative | 37 | 50 | — | 35,125 | 35,125 |
| (Class 0) | | | | | |
| Cough | 11 | 49 | 0 | 1,703 | 1,703 |
| (Class 1) | | | | | |
| Sneeze | 42 | 68 | 1,245 | 219 | 1,464 |
| (Class 2) | | | | | |

Annotation was done in per-frame classification fashion. The labels used were:
No event (blank)—equivalent to negatives;
Event onset-onset to cough or sneeze;
Event active-cough or sneeze;
Event offset-offset to cough or sneeze; or
Garbage-irrelevant frames (participant not in frame, etc.).

The analysis produced evidence selection of the input time window for audio and visual models, and the frame rate for the visual model

Table 7 shows metrics for audio measured using F1 and FPR as measurements. The best F1-score and FPR on the audio branch was achieved with a window size of 2 seconds.

TABLE 7

| Audio Window length (s) | F1-score | FPR |
|---|---|---|
| 0.5 | 0.462 | 0.200 |
| 1.0 | 0.471 | 0.174 |
| 1.5 | 0.580 | 0.142 |
| 2.0 | 0.712 | 0.126 |

Table 8 shows metrics for video measured using the F1-score. The best F1-score on the visual branch was achieved with a window size of 2 seconds at 10 FPS.

TABLE 8

| | | | | |
|---|---|---|---|---|
| F1 | 5 FPS | 10 FPS | 15 FPS | 20 FPS |

| | | | | | |
|---|---|---|---|---|---|
| Video | 0.5 s | 0.530 | 0.510 | 0.525 | 0.531 |
| window | 1.0 s | 0.520 | 0.538 | 0.539 | 0.529 |
| length | 1.5 s | 0.548 | 0.551 | 0.570 | 0.535 |
| | 2.0 s | 0.554 | 0.656 | 0.550 | 0.538 |

Table 9 shows metrics for video measured using FPR. The best FPR on the visual branch was achieved with a window size of 1.5 seconds at 10 FPS.

TABLE 9

| | | | | |
|---|---|---|---|---|
| FPR | 5 FPS | 10 FPS | 15 FPS | 20 FPS |

| | | | | | |
|---|---|---|---|---|---|
| Video | 0.5 s | 0.149 | 0.165 | 0.152 | 0.182 |
| window | 1.0 s | 0.144 | 0.148 | 0.159 | 0.171 |
| length | 1.5 s | 0.117 | 0.120 | 0.124 | 0.143 |
| | 2.0 s | 0.122 | 0.156 | 0.134 | 0.131 |

Table 10 shows how, accounting for the results between the audio branch and visual branch, the input configurations of window size of 2 seconds at frame rate of 10 FPS are chosen for evaluating the fusion model against the audio-only and visual-only models. Higher F1-score and lower FPR on the fusion models were achieved compared to the audio-only and visual-only models.

TABLE 10

| Experiments | F1-score | FPR |
|---|---|---|
| Audio-only | 0.712 | 0.126 |
| Visual-only | 0.656 | 0.156 |
| Fusion | 0.713 | 0.121 |
| Fusion (with frame metadata) | 0.758 | 0.102 |

Adding the frame metadata also showed significant improvements to the model's performance in both F1-score and FPR. The frame metadata used are:
The percentage of tracked face within the 2 seconds-long window;
The percentage of blurry images within the 2 seconds-long window; and
The minimum and maximum amplitudes of the audio in the 2 seconds-long window.

The frame metadata is concatenated into a 1-D array and passed directly into the fusion model in a separate branch with several fully connected layers, before concatenating with the inputs from the audio and visual branches further down the fusion model.

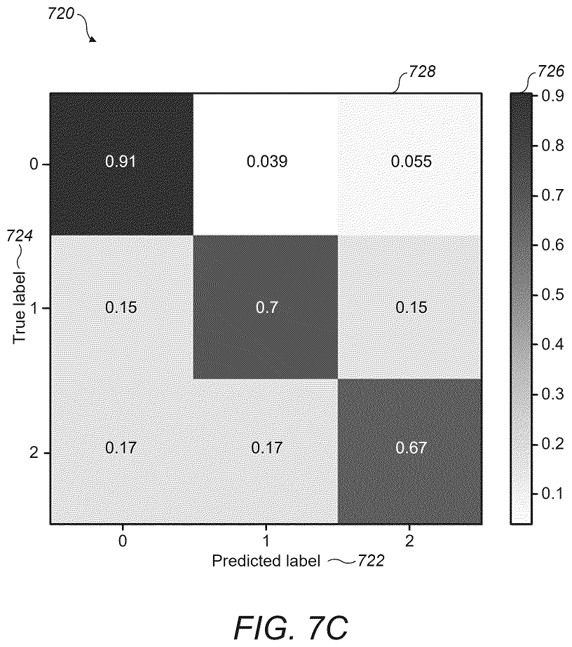

FIGS. 7A, 7B, and 7C show evidence of improved accuracy and reduced false positive rate.

FIG. 7A shows the confusion matrix results 700 for a “video only” model with a F1 chart 708 comparing predicted labels of class 0 (negatives), class 1 (coughs), and class 2 (sneezes) 702 against the true labels of class 0 (negatives), class 1 (coughs), and class 2 (sneezes) 704. As shown in the key 706, a darker square means a higher F1.

FIG. 7B shows the confusion matrix results 710 for an “audio only” model with a F1 chart 718 comparing predicted labels of class 0 (negatives), class 1 (coughs), and class 2 (sneezes) 712 against the true labels of class 0 (negatives), class 1 (coughs), and class 2 (sneezes) 714. As shown in the key 716, a darker square means a higher F1.

FIG. 7C shows the confusion matrix results 720 for a “fusion with frame metadata” model with a F1 chart 728 comparing predicted labels of class 0 (negatives), class 1 (coughs), and class 2 (sneezes) 722 against the true labels of class 0 (negatives), class 1 (coughs), and class 2 (sneezes) 724. As shown in the key 726, a darker square means a higher F1.

The results shown in these FIGS. 7A, 7B, and 7C are further detailed in Table 11

TABLE 11

| Model→ | Video | Audio | Fusion with |
|---|---|---|---|
| Class↓ | Only | Only | Frame Metadata |
| Class 0 (negatives) FPR | 0.225 | 0.132 | 0.157 |
| Class 0 (negatives) F1 | 0.821 | 0.834 | 0.899 |
| Class 1 (coughs) FPR | 0.171 | 0.055 | 0.067 |
| Class 1 (coughs) F1 | 0.603 | 0.708 | 0.733 |
| Class 2 (sneezes) FPR | 0.072 | 0.191 | 0.083 |
| Class 2 (sneezes) F1 | 0.537 | 0.481 | 0.640 |
| Average FPR | 0.156 | 0.126 | 0.102 |
| Average F1 | 0.656 | 0.712 | 0.758 |

Example 4 shows that on the cough and sneeze detection task, the probabilistic audiovisual fusion can achieve noticeably better recognition performance, compared to the unimodal (audio only and video only) models. When combined with the frame metadata, the fusion model's performance improves further. Overall, these results demonstrate that the multimodal fusion guided by predictive probability distributions is more reliable than the unimodal models.

### V. BEHAVIORS RELATED TO THE ONSET OF MOTION SICKNESS

### A. Motion Sickness Onset

When humans get motion sick their expressive behavior changes in a measurable way.

Using any combination of the following as input features into our temporal behavior pipeline this behavior can be reliably detected:
Face muscular actions, specifically but not limited to, AU 4 (brow lowerer), AU 10 (upper lip raiser), AU 23 (lip tightener), AU 24 (lip pressor), and AU 43 (eye closed);
Skin tone-a significant number of people go pale;
The appearance of perspiration on the forehead and face;
Body pose-fidgeting and reaching motions;
Head pose-distinctive head actions expressed when feeling dizzy and sick;
Occlusion of the face with hand;
The visual appearance of the cheeks-due to cheek puffing;
Audio associated with blowing out-telltale puffing/panting behavior;
Clearing the throat and coughing; and
Excessive swallowing.

Once detected the driver can be alerted or in-car mitigation features can be enabled.

### B. Analysis of Motion Sickness Dataset

### Example 5

In this Example 5, an in-car video dataset for motion sickness was collected and analyzed for facial muscle actions and behavioral actions (head motion, interesting behaviors, and hand positions) during the time period when the subject appeared to be affected by motion sickness. Table 12 lists the facial muscle actions observed and the percentage of videos in which these actions were found to occur during the sections where the participant was experiencing motion sickness. Table 13 lists the behavioral actions observed and the percentage of videos in which these actions were found to occur during the sections where the participant was experiencing motion sickness.

TABLE 12

| Facial Muscle Actions | Percentage |
|---|---|
| AU 4 (brow lower) | 92.3 |
| AU 43 (eyes closed) | 84.6 |
| AU 10 (upper lip raiser) | 61.5 |
| AU 25/26 (lip part/jaw drop) | 38.5 |
| AU 34 (cheek puffer) | 30.8 |
| AU 15 (lip corner depressed) | 23.1 |
| AU 17 (chin raiser) | 23.1 |
| AU 18 (lip pucker) | 23.1 |
| AU 13/14 (sharp lip puller/dimpler) | 15.4 |
| AU 1 or AU 2 (brow raised) | 7.7 |
| AU 9 (nose wrinkler) | 7.7 |
| AU 23 (lip tightener) | 7.7 |

TABLE 13

| Behavioral Actions | Percentage |
|---|---|
| Hand on mouth | 61.5 |
| Hand on forehead | 23.1 |
| Hand on chest | 23.1 |
| Leaning forward | 23.1 |
| Coughing | 15.4 |

Monitoring these facial and behavioral actions outlined in Table 12 and Table 13 for temporal patterns using the in-cab temporal behavior pipeline leads to a motion sickness score. While some AUs (e.g., lip tightener) and behaviors (e.g., coughing) have low occurrences across the dataset, the combinatorial nature of the temporal patterns makes them important to observe.

### VI. DRIVER HANDOVER CONTROL MONITORING

As driver assistance and self-driving systems become more common and capable there is a need for the car to understand when it safe and appropriate to relinquish or take control of the vehicle from the driver.

The disclosed system is used to monitor the driver using a selection of the following inputs:
Driver attention;
Driver distraction state;
Driver current mood; and
Any detected driver incapacitation or extreme health event.

A confidence-aware stochastic process regression bases fusion model is then used to predict a handover readiness score. Very low scores indicate that the driver is not sufficiently engaged to take or have control of the vehicle. And very high scores indicate that the driver is ready to take control.

### VII. EXTREME HEALTH EVENT ALERTING SYSTEM

The accurate detection of extreme health events enables this system to be used to provide data on the occupants' health and trigger the cars' emergency communication/SOS system. These systems can also then forward the information on the detected health event to the first responders so that they can arrive prepared. This will save vital time enhancing the chances of a better outcome for the occupant. Detected events include, without limitation:
Heart attacks;
Stroke;
Loss of consciousness; and
Dangerous diabetic coma.

### VIII. CONCLUSION

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1-6. (canceled)

7. A system comprising:
a task for an automobile interior having at least one subject that creates a video input;
an extractor for extracting facial features data relating to the at least one subject from the video input;
wherein the facial features date is processed by a recurrent neural network to produce predictions related to which of the at least one subject created a sound of interest.

8. The system as in claim 7, wherein the facial features data comprise facial muscular actions.

9. The system as in claim 8, wherein the facial muscular actions comprise movement of lips.

10. The system as in claim 7, wherein the facial features data comprise geometric facial actions.

11. The system as in claim 10, wherein the facial features data comprise geometric facial actions.

12. The system as in claim 11, wherein the geometric facial actions comprise movements of lips and a nose.

13. The system as in claim 7, further comprising:
a trainer to train the recurrent neural network of temporal relationships between the sound of interest and facial appearance over a specified time window via videos of facial muscular actions.

14. The system as in claim 13, wherein the videos of facial muscular actions have between 15 and 30 frames per second.

15. The system as in claim 13, wherein the recurrent neural network does not use audio input to produce the predictions.

16-29. (canceled)
